(19) United States
(12) Patent Application Publication
(10) Pub. No.: US 2008/0201648 A1
(43) Pub. Date: Aug. 21, 2008

(54) Web page-embedded dialogs

(75) Inventors: Jeremy Earp, Snoqualmie, WA (US); Travis Leithead, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/708,264

(22) Filed: Feb. 20, 2007

(51) Int. Cl. G06F 3/048

(52) U.S. Cl. 715/762

(57) ABSTRACT

Various embodiments enable creation of dialogs in a manner that binds them to the page from which they were created. In at least some embodiments, dialogs can be created and rendered as part of a page's elements. In this manner, dialogs can be embedded in the web pages themselves or, more accurately, in the markup language that defines the web page.

### BACKGROUND

In browsing scenarios, additional windows called dialogs can typically be spawned from within a parent window. These dialogs are typically spawned via script or code that executes on a web page. Such script-spawned dialogs can be problematic for a couple of different reasons.

First, many times when such dialogs are spawned, they are modal dialogs. A modal dialog is one that requires attention before the current process can continue. As such, modal dialogs cannot simply be placed aside to work on other things. That is, a model dialog typically requires the user to make a choice and take some action. Until such is done, the user is prevented from taking any other action in the parent window or, for that matter, with their web browser. This can be particularly problematic in the context of tabbed browsing. With tabbed browsing, a user can open, within a single browser window, multiple web pages that are represented as tabs in the user interface. When a user wishes to switch to one of the web pages, they simply click on the appropriate tab. Modal dialogs, however, can lock up the tab so that until the dialog is addressed and removed, the user is prevented from accessing their tabbed web pages. In some instances, a web site can repeatedly create such dialogs and force users to close their browser using a task manager. This creates a Denial of Service (DoS) attack.

Another problem associated with dialogs is that when some dialogs are created, there is no link back to their parent window. This can become a problem when, for example, a nefarious individual creates a dialog and tries to have it trick a user into believing it came from a page that it did not, e.g. in a spoofing attack. This can be done by simply resizing a small window in front of another “trusted” window and issuing a prompt for something such as a password.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable creation of dialogs in a manner that binds them to the page from which they were created. In this manner, the dialog is not permitted to leave the area of the page from which it was created.

In at least some embodiments, dialogs can be created and rendered as part of a page's elements. In this manner, dialogs can be embedded in the web pages themselves or, more accurately, in the markup language that defines the web page. Thus, in at least some embodiments, dialogs are represented or otherwise defined in the markup that makes up a web page. In at least some embodiments, this permits the creation of scriptless dialogs or, dialogs that can be created without the use of script.

### BRIEF DESCRIPTION OF THE DRAWINGS

The same numbers are used throughout the drawings to reference like features.

FIG. 1 illustrates a system in which various principles described herein can be employed in accordance with one or more embodiments.

FIG. 2 illustrates a browser window having an example dialog.

FIG. 3 illustrates markup that includes an embedded dialog in accordance with one or more embodiments.

FIG. 4 is a flow diagram that describes steps in a method in accordance with one or more embodiments.

FIG. 5 illustrates a web page having a dialog in accordance with one or more embodiments.

FIG. 6 illustrates a web page having a dialog in accordance with one or more embodiments.

FIG. 7 is a flow diagram that describes steps in a method in accordance with one or more embodiments.

FIG. 8 illustrates an example system that can be utilized to implement one or more embodiments.

### DETAILED DESCRIPTION

Overview

Various embodiments enable creation of dialogs in a manner that binds them to the page from which they were created. In this manner, the dialog is not permitted to leave the area of the page from which it was created. By being tied directly to the page that created it and by not being allowed outside of that page's area, the chances of a spoofing attack are at least reduced.

In at least some embodiments, dialogs can be created and rendered as part of a page's elements. In this manner, dialogs can be embedded in the web pages themselves or, more accurately, in the markup language that defines the web page. Thus, in at least some embodiments, dialogs are represented or otherwise defined in the markup that makes up a web page. In at least some embodiments, this permits the creation of scriptless dialogs or, dialogs that can be created without the use of script.

More specifically, in at least some embodiments, a markup element or some other markup construct is utilized to specify the scriptless dialog. And, while the dialog is created without the use of script, the dialog can be later manipulated by script to extend its functionality, as will become apparent below.

In the discussion that follows, a section entitled “Example System” is provided and describes one system in which one or more embodiments can be employed. Following this, a section entitled “Example Dialog” is provided and describes characteristics or features of an example dialog. Next, a section entitled “Confining Dialogs to Content Area of Parent” is provided and discusses how dialogs can be confined to the content area of their parent page so as not to overlap onto a different page. Following this, a section entitled “Scriptless Dialogs” is provided and describes how dialogs can be created in a scriptless manner in one or more embodiments. Finally, another section entitled “Example System” is provided and describes, in more detail, an example system that can be utilized to implement one or more embodiments.

Example System

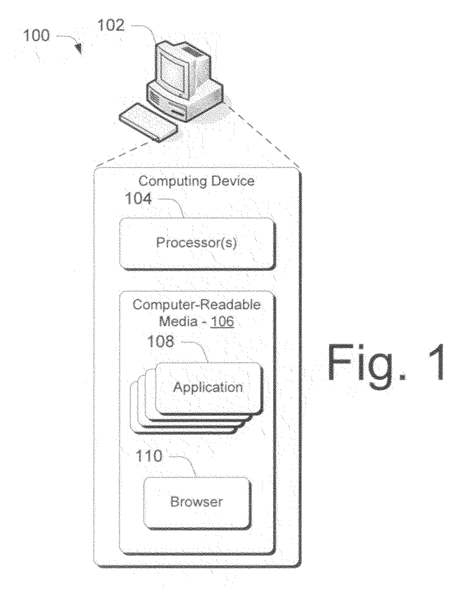

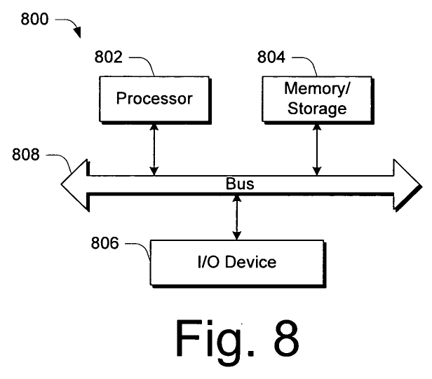

FIG. 1 illustrates a system in accordance with one or more embodiments, generally at 100. System 100 includes a computing device 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 8.

In addition, computing device 102 includes software in the form of a web browser 110. Any suitable web browser can be used examples of which are available from the assignee of this document and others.

Although computing device 102 is illustrated in the form of a desktop computer, it is to be appreciated and understood that other computing devices can be utilized without departing from the spirit and scope of the claimed subject matter. For example, other computing devices can include, by way of example and not limitation, portable computers, handheld computers such as personal digital assistants (PDAs), cell phones and the like.

Example Dialog

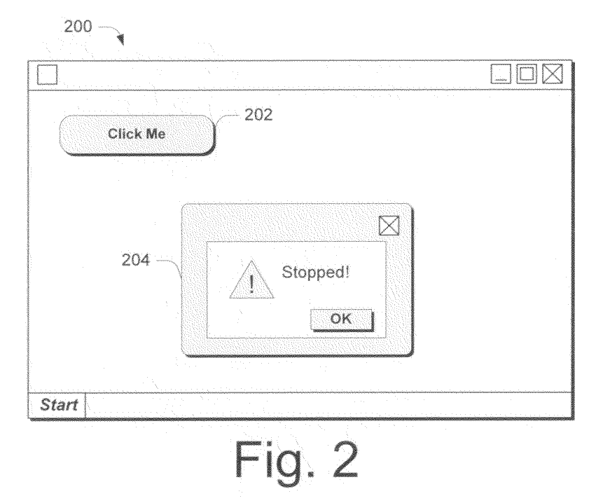

A dialog box or, more generally a dialog, is usually presented as a smaller window within a parent window that is rendered by a user's browser. As an example, consider FIG. 2. There, a browser window 200 includes a web page that has been rendered. The rendered web page includes a “Click Me” button 202. In this example, a dialog 204 has been rendered which, in this example, is a smaller window that is rendered within browser window 200—the dialog's parent window. In this example, the dialog 204 includes a message “Stopped!”, along with an “OK” button and an “X” button to close the dialog.

Dialogs can come in many shapes and sizes and convey many different kinds of content, as will be appreciated by the skilled artisan.

Confining Dialogs to Content Area of Parent

In one or more embodiments, dialogs are created and embedded in the markup language that defines a web page itself. Any suitable markup language can be used examples of which include HTML, XHTML and the like. In the ongoing example in this document, however, HTML is used. Any suitable way of embedding a dialog in a web page's markup can be used. For example, in some embodiments, the dialog can reside as part of the web page's header. Alternately or additionally, the dialog can reside within the body of the markup, an example of which is provided below.

In this manner, the dialog that is created is created as part of the web page itself. By embedding the dialog as part of a page's markup, the dialog now belongs to, and is linked with the web page.

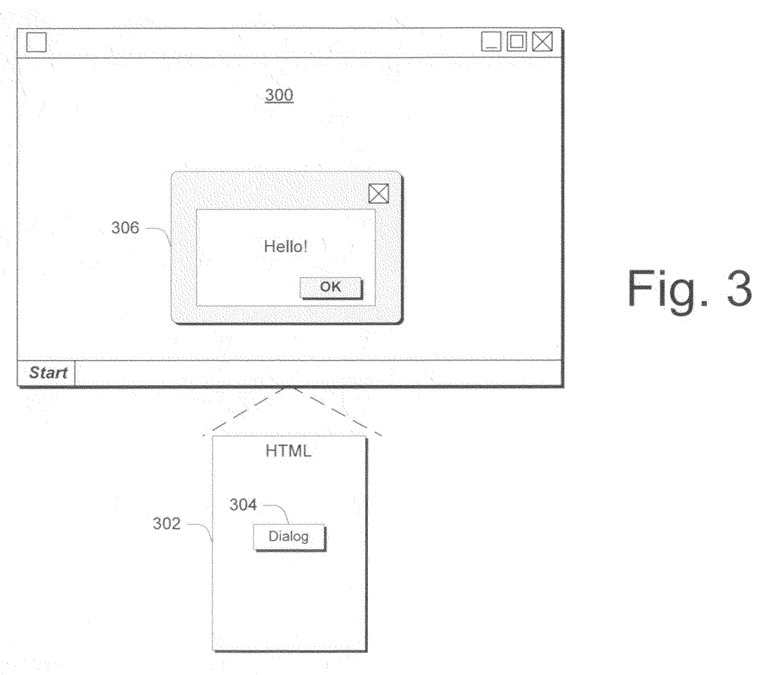

As an example, consider FIG. 3 which illustrates an example browser window 300 having a rendered web page 301. Web page 301 is defined by HTML 302. Here, HTML 302 includes an embedded dialog portion 304 which is renderable to provide a dialog 306 in web page 301. That is, when the browser parses the web page's HTML and begins rendering activities, the browser will parse the dialog portion 304 and, responsively, will create dialog 306 as part of page 301.

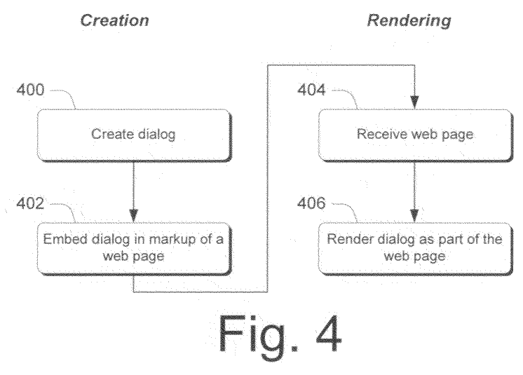

FIG. 4 illustrates a flow diagram that describes a method in accordance with one or more embodiments. The method can be implemented in connection with any suitable hardware, software, firmware or combination thereof. In at least some embodiments, part of the method can be implemented by a suitably configured web browser.

In this example, the method is separated into two different sections—one designated “Creation” and one designated “Rendering”. This is done to depict two different but related acts that are performed by the method—that of creating a dialog and that of rendering the dialog.

Step 400 creates a dialog. Any suitable way or method can be utilized to create a dialog examples of which are provided below. Creation of the dialog can include creating or defining any text associated with the dialog, along with the physical dimensions and properties of the dialog. Step 402 embeds the dialog in the markup of a web page. Any suitable techniques can be utilized to embed the dialog in the markup of a web page, and any suitable markup language can be utilized. For example, the dialog and its relevant parameters can be included in the header information of a page's HTML. Alternately or additionally, the dialog can be included within the body of the HTML.

It is to be appreciated and understood that while the above-described steps are depicted as separate steps, such steps can be performed simultaneously. For example, as an author creates the HTML for a particular web page, they can also create the dialog contemporaneously.

Once created, step 404 receives the web page. This step can be performed in any suitable way. For example, in one or more embodiments, this step can be performed by a suitably configured web browser which can receive the web page via any suitable means. Such means include, by way of example and not limitation, any suitable network such as an Intranet, Internet and the like. Step 406 renders the dialog as part of the web page. This step can be performed by parsing the markup associated with the web page, e.g. the HTML, and rendering the markup, including the markup's elements, as the web page. During the act of rendering the HTML, the dialog is created as part of the web page.

When, as above, the dialog is created as part of the web page, it can be created in such a way that it cannot leave the area of the page. That is, by being an actual part of the web page as by being embedded in the page's HTML, when the page is rendered, the dialog is confined within the page's area. This ties the dialog to a specific content area and can prevent the dialog from being used for other purposes, such as being re-sized and super-imposed on top of another web page. In one or more embodiments, dialogs can be confined to the content areas of their parents by defining certain properties of the dialog. For example, one property of a dialog can be defined, in its HTML, such that it is not allowed to be rendered outside the content area of its parent. This can include not allowing the dialog to overlap or otherwise display outside of the content area. In at least some embodiments, the content area can be defined as the rectangle within which the browser specifically displays content of the web page, or a subpage embedded within the parent page (commonly referred to as a “frame”).

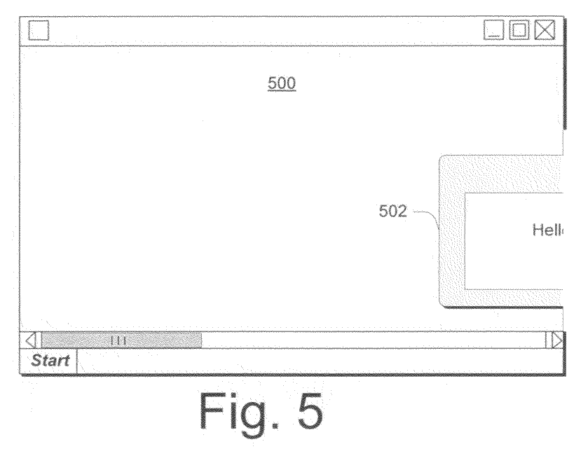

In one or more embodiments, the dialog can be dragged and repositioned inside of the content area. If a dialog starts to leave the boundary of the content area, then the web page itself can be sized to include the dialog. In this embodiment, the web page can be sized but the viewport might remain unchanged. As an example, consider FIG. 5. There, a web page 500 includes a content area within which a dialog 502 is rendered. In this example, the dialog 502 has been dragged to the far right of the content area such that a portion of it appears to extend outside of the content area. Notice here, however, that the browser window has added or otherwise included a scroll bar at the bottom to allow the user to scroll over to view the entire dialog 502.

In one or more embodiments, dialogs can be both modal and modeless. In embodiments in which a dialog is modal, the dialog can be defined in such a way that it is modal to the page from which it was spawned or page modal. In embodiments such as these, the parent web page can be visually adjusted in a manner to imply the page modality of the dialog.

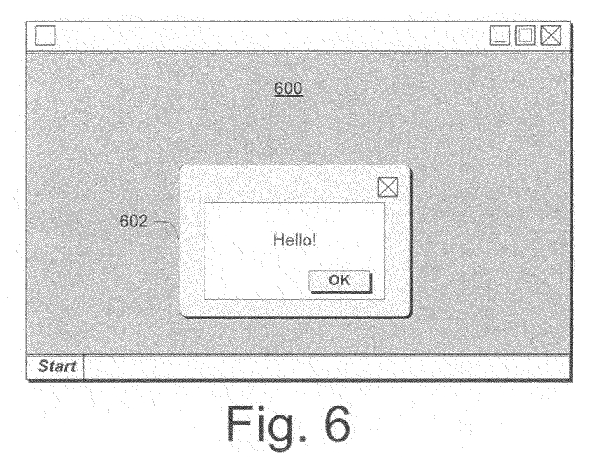

As an example, consider FIG. 6. There, a web page 600 has been grayed out so as to visually highlight the dialog 602. By graying out or otherwise distinctly visually rendering the web page associated with a dialog, the notion that the dialog is modal can be reinforced. It is to be appreciated and understood that while the dialog is page modal, it does not affect the user's ability to click to other tabs or take other actions with their browser. For example, if the user had dialog 602 displayed for them and had not yet dismissed it, they could freely tab to other web pages that they had open. Hence, the page modality of the dialog does not affect the user's ability to take other actions with their browser when the dialog has not yet been dismissed.

Having discussed how dialogs can be created and confined to the content area of their parent web page, consider now one way in which scriptless dialogs can be created.

Scriptless Dialogs

Recall that in the past, dialogs have been created using script or code that is part of the web page that spawns the dialog. In one or more embodiments, dialogs can be created to comprise a native part of the HTML that makes up a web page. In this manner, the dialog can be embedded directly in the web page itself As indicated above, any suitable way of embedding the dialog in the web page can be utilized. Embedding dialogs in web pages as a native part of the page's HTML can allow for easy theming via cascading style sheets (CSS) as will be appreciated by the skilled artisan. Further, HTML embedded dialogs can permit easy modification and alteration by script after they are rendered. And, since the dialog “belongs” to the parent page, it can be moved around the page as needed, but does not leave the page. As an example of how a scriptless dialog can be defined as part of a web page's HTML, consider the following:

```
<html>
  <body>
    <p>This page has a cool dialog</p>
    <dialog>This message is the dialog</dialog>
  </body>
</html>
```

In this example, the HTML includes a tag designating the body of the HTML. Within the body of the HTML, a pair of <dialog> tags defines the content of the dialog. In this simple example, the dialog is simply the message “This is the dialog”. In this example, the dialog is modeless and can be positioned using default values or other values that can be defined by properties within the HTML itself As an example, consider the HTML just below:

```
<html>
  <body>
    <dialog width=200px height=400px title=”Example Dialog”>
            This is an example dialog.
    </dialog>
  </body>
</html>
```

Here, the dialog that is defined in the HTML includes dimensions that include width and height dimensions. In addition, one of the properties includes a title of the dialog. In this example, the title is “Example Dialog”. The content of the dialog follows the title property in this example.

In this example, dialogs that are created are the direct children of the web page or content area that created them. As a consequence, these dialogs cannot be dragged, resized or otherwise positioned outside of this content area. In one or more embodiments, dialogs are, by default, modeless and visible. This can enable scenarios in which a web site can spawn multiple floating dialogs that can be used within a web application.

In one or more embodiments, various properties can be defined for the scriptless dialogs. By way of example and not limitation, consider the table just below and its definition of various properties associated with scriptless dialogs.

| Property | Definition |
|---|---|
| Top, Left, Height, Width | These properties specify where the dialog is |
| | positioned and how it is sized. |
| Title | Specifies the title of the dialog as displayed |
| | in the title bar of the dialog. |
| SRC | Specifies the location of the page used for |
| | the dialog contents. This location (for |
| | security reasons) is relative (or local to the |
| | parent page's domain). If SRC is specified, |
| | the content (title tag) within the SRC page |
| | overrides the Title attribute and any inline |
| | content that may be specified. |
| Visible | Determines if the dialog is visible at |
| | startup. |
| Modal | Determines if the dialog is modal. |
| Style/CSS | Specifies if a style sheet should be used to |
| | modify the border and the title bar of the |
| | dialog. |
| Resizable | Determines if the dialog can be resized. |
| DockLeft, DockRight, | Specifies if a dialog should be docked to |
| DockTop, DockBottom, | the content area or another dialog and by |
| DockTarget, Docked | how much (specified in px). |

In one or more embodiments, a dialog can have the same lifetime as the parent page from which it was spawned. Thus, when the parent page is destroyed (e.g., by navigating away, closing tab/window, etc) the dialog(s) that belongs to the page is also destroyed. Alternately or additionally, dialogs can also have methods and events that are exposed through script. For example, Show and Hide methods can be used to show and hide the same dialog multiple times. An OnClose event can be used to perform an action on the parent page when a dialog is closed. Alternately or additionally, scriptless dialogs can also be used to replace various methods, examples of which include, by way of example and not limitation, window.alert( ), window.confirm( ), window.prompt( ), and other “built-in” dialogs that are currently available in script. These changes would not result in any change in functionality with respect to the web page script. Only the user experience would change.

Alternately or additionally, modal scriptless dialogs, as pointed out above, can be “page modal” or modal only to the page. Modal scriptless dialogs thus only block the parent page. In the tabbed environment, users are still free to tab to another page, switch to other windows or close the parent page. Alternately or additionally, as in the example above, modal scriptless dialogs, when displayed, can result in a dimmed parent page behind the dialog.

In one or more embodiments, attributes or properties specified in a scriptless dialogs can be optional and, if not specified, various default values can be used. For example, excluding the title property can result in either a default title or no title being used.

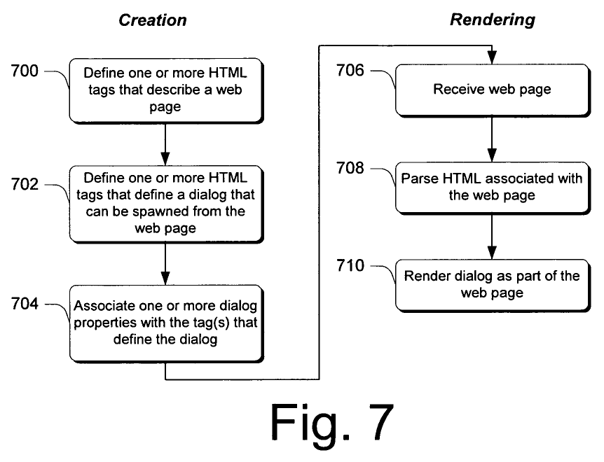

FIG. 7 illustrates a flow diagram that describes a method in accordance with one or more embodiments. The method can be implemented in connection with any suitable hardware, software, firmware or combination thereof. In at least some embodiments, part of the method can be implemented by a suitably configured web browser.

In this example, the method is separated into two different sections—one designated “Creation” and one designated “Rendering”. This is done to depict two different but related acts that are performed by the method—that of creating a dialog and that of rendering the dialog.

Step 700 defines one or more HTML tags that describe a web page. Examples of how this can be done are given above. Step 702 defines one or more HTML tags that define a dialog that can be spawned from the web page. Examples of how this can be done are given above. Step 704 associates one or more dialog properties with the tag(s) that define the dialog. Example properties are provided above.

Step 706 receives the web page and step 708 parses the HTML associated with the web page. Step 710 then renders the dialog as part of the web page.

Example System

FIG. 8 illustrates an example computing device 800 that can implement the various embodiments described above. Computing device 800 can be, for example, computing device 102 of FIG. 1 or any other suitable computing device.

Computing device 800 includes one or more processors or processing units 802, one or more memory and/or storage components 804, one or more input/output (I/O) devices 806, and a bus 808 that allows the various components and devices to communicate with one another. Bus 808 represents one or more of any of several types of bus structures, including a memory bus or memory controller, a peripheral bus, an accelerated graphics port, and a processor or local bus using any of a variety of bus architectures. Bus 808 can include wired and/or wireless buses.

Memory/storage component 804 represents one or more computer storage media. Component 804 can include volatile media (such as random access memory (RAM)) and/or nonvolatile media (such as read only memory (ROM), Flash memory, optical disks, magnetic disks, and so forth). Component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

### CONCLUSION

Various embodiments enable creation of dialogs in a manner that binds them to the page from which they were created. In this manner, the dialog is not permitted to leave the area of the page from which it was created. By being tied directly to the page that created it and by not being allowed outside of that page's area, the chances of a spoofing attack are at least reduced.

In at least some embodiments, dialogs can be created and rendered as part of a page's elements. In this manner, dialogs can be embedded in the web pages themselves or, more accurately, in the markup language that defines the web page. Thus, in at least some embodiments, dialogs are represented or otherwise defined in the markup that makes up a web page. In at least some embodiments, this permits the creation of scriptless dialogs or, dialogs that can be created without the use of script.

More specifically, in at least some embodiments, a scriptless dialog utilizes a markup element, or some other markup construct, to specify the dialog. While not using script to create the dialog, the dialog can be later manipulated by script to extend its functionality.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
creating a dialog; and
embedding the dialog in markup language that defines a web page.

2. The method of claim 1, wherein said creating comprises defining dialog text and one or more properties associated with the dialog.

3. The method of claim 2, wherein one property specifies where the dialog is positioned and how it is sized.

4. The method of claim 2, wherein said properties comprise: a property that specifies a title of the dialog that is displayed in a title bar; and a property that specifies whether the dialog is visible.

5. The method of claim 2, wherein one property specifies whether a dialog is modal.

6. The method of claim 5, wherein a modal dialog is page model to the web page from which it is spawned.

7. The method of claim 2, wherein one property specifies if a style sheet should be used with the dialog.

8. The method of claim 2, wherein one property specifies whether the dialog is resizable.

9. The method of claim 2, wherein one property specifies if the dialog should be docked.

10. The method of claim 1, wherein said embedding comprises including the dialog within a body of the markup language, wherein the markup language comprises HTML.

11. The method of claim 1, wherein said act of creating comprises creating the dialog in a manner in which it can be rendered without script that defines the dialog.

12. A computer-implemented method comprising:
receiving a web page defined in a markup language; and
rendering one or more dialogs that are embedded in the markup language as part of a rendered web page.

13. The method of claim 12, wherein the dialog is embedded as an HTML element.

14. The method of claim 12, wherein the dialog cannot leave an area of the rendered web page.

15. The method of claim 12, wherein said one or more dialogs can be modal or modeless.

16. The method of claim 15, wherein modal dialogs are page modal to the rendered web page.

17. The method of claim 12, wherein said act of rendering comprises rendering the web page in a visually distinct manner from at least one of the dialogs.

18. The method of claim 12, wherein the act of rendering comprises rendering the one or more dialogs without script which defines the one or more dialogs.

19. One or more computer-readable media comprising:
HTML that defines a web page; and
a dialog portion embedded in the HTML and defining a dialog, the dialog being renderable without script that defines the dialog.

20. The one or more computer-readable media of claim 19, wherein the dialog is embedded in a body of the HTML as a tagged page element having one or more properties.
